(19) United States
(12) Patent Application Publication
(10) Pub. No.: US 2011/0141359 A1
(43) Pub. Date: Jun. 16, 2011

(54) In-Program Trigger of Video Content

(75) Inventors: Jay DiGiovanni, Voorhees, NJ (US); Gregory House, Doylestown, PA (US)

(73) Assignee: PVI Virtual Media Services, LLC, Bethpage, NY (US)

(21) Appl. No.: 12/813,230

(22) Filed: Jun. 10, 2010

Related U.S. Application Data
(60) Provisional application No. 61/186,264, filed on Jun. 11, 2009.

(51) Int. Cl. H04N 5/445

(52) U.S. Cl. 348/563; 348/E05.099

(57) ABSTRACT

Methods and systems for triggering an in-program display event are provided. In an embodiment, a method for triggering an in-program display event may include perfotining a video content analysis of a program display. The method may also include determining a display event trigger in real time based on the video content analysis. The method may further include displaying a display event in the program display based on the display event trigger. In some cases, the display event may be an interactive session. In another embodiment, a system for triggering an in-program display event may include a trigger mechanism and an insertion module.

### CROSS REFERENCE TO RELATED APPLICATIONS

This application claims the benefit of U.S. Provisional Appl. No. 61/186,264, filed Jun. 11, 2009, which is hereby incorporated by reference in its entirety.

### FIELD OF INVENTION

Embodiments of this invention relate to video media provided for television, mobile devices and the Internet.

### BACKGROUND

Interactive sessions in video media allow for user input and involvement. Coordination of interactive sessions with video content is a challenge for television, internet and mobile device platforms. For cable television, the prevalent approach to enabling interactive sessions involves a time scheduling scheme. Interactivity is pre-programmed to occur with fixed start and end times, corresponding to a commercial or time window in the pre-recorded program. Interactive content appears synchronized to the video achieved by selecting the appropriate time offset relative to the beginning of a program. In the case of television commercials, interactivity is often scheduled for the entire 30 second clip, none of a program, or for various windows of time in between. However, these methods of interactivity are generally fixed and do not provide for more flexible interactivity based on cues or real time events that do not follow an exact, predetermined timeline.

### BRIEF SUMMARY

Embodiments of the invention relate to triggering in-program display events. The term “in-program” may be, for example, the time period from start to end of a television program or coverage of a live event (sports or otherwise). For instance, something in a video scene of a sporting event may automatically trigger a display event, such as inserting an advertisement graphic into the video display. In other cases, a display event may be an interactive session.

According to an embodiment, a method for triggering an in-program display event may include performing a video content analysis of a program display and determining a display event trigger in real time based on the video content analysis. The method may also include displaying a display event in the program display based on the display event trigger.

A method for triggering an in-program display event may include receiving camera information corresponding to a program display, according to an embodiment. The method may also include determining a display event trigger in real time based on the camera information. The method may further include displaying a display event in the program display based on the display event trigger.

According to a further embodiment, a method for providing an in-program interactive session may include receiving trigger information in real time for triggering an in-program display event. The method may also include displaying the display event in the program display based on the display event trigger. The method may further include providing the in-program interactive session. The in-program interactive session may include enabling a user to provide input to alter the in-program display event.

According to another embodiment, a system for triggering an in-program display event includes a trigger mechanism configured to perform a video content analysis of a program display and determine a display event trigger in real time based on the video content analysis. The system may also include an insertion module configured to display a display event in the program display based on the display event trigger.

According to a further embodiment, a system for triggering an in-program interactive session may include a trigger mechanism configured to receive camera information corresponding to a program display and determine a display event trigger in real time based on the camera information. The system may also include an insertion module configured to display a display event in the program display based on the display event trigger.

According to an embodiment, a system for triggering an in-program interactive session may include a trigger mechanism configured to receive trigger information for triggering an in-program display event. The system may also include an insertion module configured to display the display event in the program display based on the display event trigger and provide the in-program interactive session. The in-program interactive session may enable a user to provide input to alter the in-program display event.

### BRIEF DESCRIPTION OF DRAWINGS

Embodiments of the invention are described with reference to the accompanying drawings. In the drawings, like reference numbers may indicate identical or functionally similar elements. The drawing in which an element first appears is generally indicated by the left-most digit in the corresponding reference number

FIG. 1 illustrates an in-program trigger of a display event, according to an embodiment.

FIG. 2 illustrates select video content that may be used to trigger a display event, according to an embodiment.

FIG. 3 illustrates an example sequence for activating interactive content, according to an embodiment.

FIG. 4 illustrates a method for virtual insertion with a corresponding display event, according to an embodiment.

FIG. 5 illustrates a high level diagram of a live video insertion system, according to an embodiment.

FIG. 6 is a diagram illustrating an example computing device which may be used in embodiments.

### DETAILED DESCRIPTION

While the embodiments described herein refer to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Embodiments of the invention relate to triggering in-program display events, such as a graphic or interactive session. The term “in-program” may be, for example, the time period from start to end of a television program or coverage of a live event (sports or otherwise). For some embodiments, an interactive session may also be considered to be triggered “in-program” if any of the following happens during the main program:
Deciding whether or not an interactive session is made available.
Deciding the chronological time for providing the interactive session.
Deciding the interactive content being provided.
Deciding the content in the main program that is synchronized with the interactivity.
   In some broadcast scenarios, program content may be made available to an end user in a linear time fashion. In other cases, in-program may refer to the portion of video directly managed by original program production. In these cases, “in-program” may or may not include video displayed during commercial breaks of the main in-program content.

The embodiments describe below illustrate example methods and systems for providing an in-program display event. The embodiments described below are applicable to platforms streaming video media, including but not limited to, television (broadcast, cable, satellite, fiber), mobile devices (cell phone or other wireless devices) and the Internet.

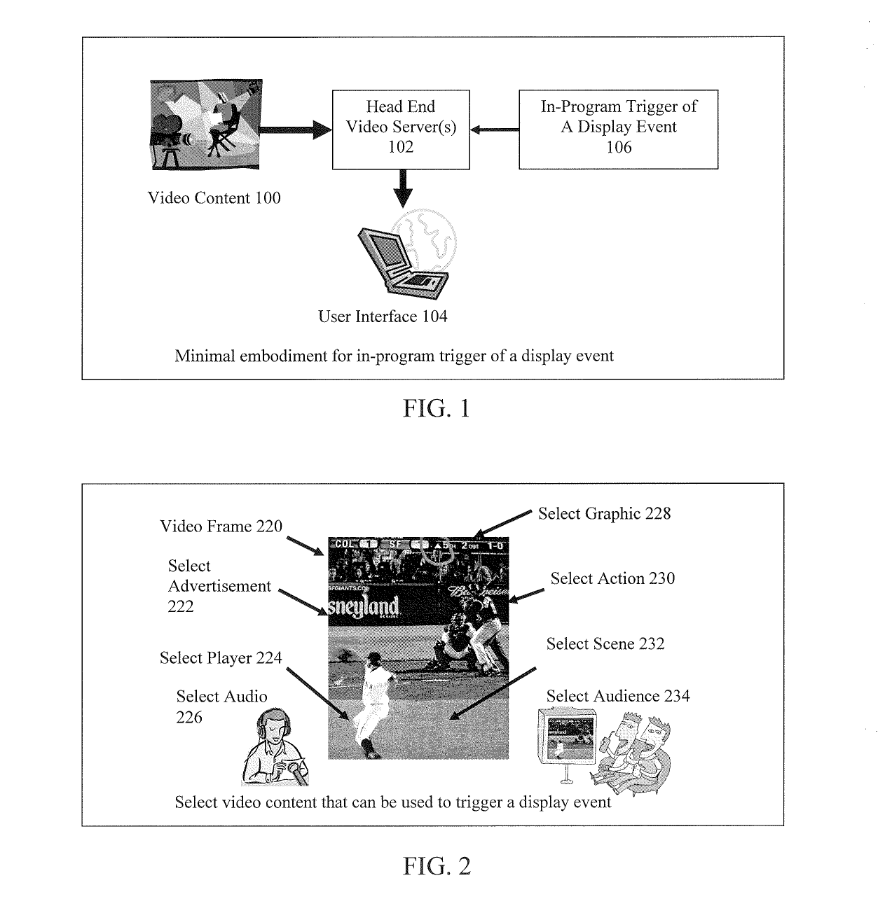

FIG. 1 shows an exemplary system for providing an in-program display event, such as a graphic or an interactive media session, according to an embodiment. Video content 100 is streamed live from a production facility or made available in a recorded medium. The head-end video server 102 streams the live or pre-recorded content through one or more distribution channels to the end-user. The end user interface 104 can vary depending on whether the distribution media is internet, wireless for mobile devices, or television.

According to some embodiments, a display event trigger may be determined based on an analysis of video content. In other cases, a display event trigger may be determined based on camera information, such as pan, tilt, zoom and point of view information. Determinations may be made in real time while the video program is being displayed to or observed by an end-user. In some embodiments, a display event trigger for an interactive session may be determined by analyzing an interactive history of a user or group of users. In other cases, such an analysis may be used to determine what display event to display. An interactive history may help determine whether a viewer will opt-into or is automatically opted-into an interactive session. For example, a viewer with a history of less interactivity may be provided with an alternate or enhanced interactive session to increase participation.

A display event may be displayed in the program display based on the display event trigger, according to a further embodiment. This display event may be a graphic. This display event may also be an interactive session. The interactive session may involve interactive control. In the case of cable television systems or other media provider systems, interactive control is communicated from the head-end to the set-top box using Enhanced TV Binary Interchange Foiinat (EBIF). An equivalent mechanism exists for enabling content to mobile and internet devices. In on-demand scenarios, a user may control the viewing and interruptions of the viewing of the main program content. According to some embodiments, interactive sessions may be implemented as described in embodiments of U.S. patent application Ser. No. 12/541,037, the contents of which are hereby incorporated by reference in their entirety.

Embodiments also address the problem of how display event capabilities are controlled in-program. In some cases, some aspects of a graphic or an interactive session may be established prior to a program while other aspects may be determined during the program. As an example, artwork used in an interactive session may be created in advance, but where to display the artwork is a real-time decision. In another example, a display event may be determined or generated in real-time after a display event trigger is determined.

Some of the aspects described above may be performed by a display event trigger mechanism. For example, FIG. 1 shows trigger mechanism 106. The trigger mechanism 106 in FIG. 1 can be placed at a variety of locations in deployed interactive system, according to embodiments. For a live television broadcast over cable, these may include:
The production facility where program video is created. This has the natural advantage that the show can be modified to provide the best opportunities for interactive content.
The studio where commercials are added. This has the advantage of being a central location that interactivity for multiple programs can be coordinated from a single location.
The head-end where the video is streamed and interactivity is enabled. This makes the sense from the perspective that control of interactive session flows from this location.
The end-user location where number of viewers of the program is counted. A method would be needed to convert viewer-ship information into whether an interactive session is provided to the end user.

Trigger information may be received, according to an embodiment. In some cases, the trigger mechanism 106 in FIG. 1 may be controlled through a manual means. In another embodiment, trigger mechanism 106 may be controlled through an automated means. The manual or automated approach may apply to the four types of decisions for inserting interactive content:
Deciding whether or not an interactive session is made available to the end user. This can be a remote trigger using a cell phone or an automated approach to decide interactivity based on viewer-ship levels.
Deciding the chronological time for providing the interactive session. This can be manually pre-scheduled or triggered based on an object automatically detected in the video.
Deciding the interactive content being provided. This can be changed manually between main and re-run showings of the program content, or triggered based on the scenes shown in a live sports broadcast.
Deciding the content in the main program that is synchronized with the interactivity. This can be a physical object in the scene (manual) or a virtually inserted object in the scene (automated).

FIG. 2 contains an example program display of a sporting event, according to an embodiment. FIG. 2 shows an image that is a typical video frame 220 of a baseball game with a pitcher on the mound; and a batter, catcher and umpire near home plate. It highlights a number of strategies for enabling a graphic or interactive content based on the input video. The content of the video may be analyzed. Examples of video content analysis are provided below.

According to an embodiment, a video content analysis may include analyzing one or more portions of or physical objects in a scene of the program display. For example, a select advertisement for Disneyland is partially visible on the back wall 222. Interactive content corresponding to the signage may be made available to the end-user whenever the signage is visible in the frame. Alternately, interactivity can be enabled for the entire half inning that the signage is present, whether visible in the frame or not (i.e. top of the 2^{nd}). Note that this applies whether the signage physically exists in the stadium, or is virtually inserted to appear to be in the stadium.

In another example, a select San Francisco Giant pitcher is present on the mound 224. User selectable performance statistics or personal data about the pitcher may be interactively provided when the pitcher is on the mound. This may be tied into a system that derives motion data about players as in U.S. patent application Ser. No. 61/079,203, the contents of which are hereby incorporated by reference.

According to another embodiment, video content analysis may include analyzing audio of the program display. A selected program audio 226, such as the announcers' promotional message, may be used as a basis for triggering interactive advertisements. In other embodiments, data from other data sources may be analyzed to determine a display event trigger or a display event. This may include, but is not limited, to alternate audio channel or PROGRAM ID (PID) data channels associated with video channels in cable, satellite or broadcast distribution. This may be performed as part of the video content analysis. In one embodiment, the alternate data sources may consist of field of view data acquired through sensors mounted on the camera tripod, on the camera lens or internal to the camera lens. In an alternate embodiment, the alternate data sources may consist of metadata indicating a target location or region in the scene, such as the position of home plate in video sequence of a baseball game. In a further embodiment, the alternate data source may be embedded as part of the video channel itself.

Video content analysis may include analyzing an inserted graphic of the program display, according to a further embodiment. For example, a selected broadcast graphic with pertinent data about the game spans the top of the frame 228. This information may be used to trigger a promotion, for example whenever the score is tied. The trigger mechanism may be automated using character recognition algorithms performed on the graphic. For example, this may be extended to derive a game time of a sporting event. A game time may include a game time increment (first period, second inning, 10 minutes left in the half, time since beginning of event, etc.) for enabling/disabling/modifying interactive features or content.

In another embodiment, video content analysis may include analyzing one or more events in a scene of the program display. For example, a selected action related to a game such as a homerun swing 230 may trigger a display or interactive session. A homerun contest may enable a coupon for a free soda at a local convenience store whenever a homerun occurs.

In another example, a selected scene 232 may be the catalyst for providing a graphic or enabling interactive content. For instance, an interactive link to a sailboat retail shop may be provided whenever the waterfront near a stadium is framed in view. In other cases, the appearance of a target area for an advertisement may be determined to be a display event trigger.

In a further example, a select audience action 234 may be used to control the availability of interactive features. For example, the amount of interactive benefits provided to viewers can be throttled by total viewer-ship. Alternately, interactive response early in the program can be used to change interactive content later, such as the results of an opinion survey.

The strategies for triggering interactivity in FIG. 2 can be extended to pre-recorded content as well. The following examples are given. First, a sponsor's product can be virtually inserted in the scene (like back wall signage like advertisement 222) and corresponding interactive links can be enabled. Second, personal information about a cast member can be given in place of data of ballplayers. Third, actors saying their trademark lines can trigger an interactive link to the television shows fan club web page. Fourth, broadcast promotion burn-in graphics can trigger interactive information about upcoming shows. Fifth, cast member actions such as a car chase can trigger advertisements about automobiles. Sixth, the variety of outdoor scenes in some programs lends itself to a greater range of advertising. Finally, the audience participation can extend viewer interest as seen in text messaging on a popular television talent show. Note, this is an example of using multiple media simultaneously (wireless and television) to achieve interactivity.

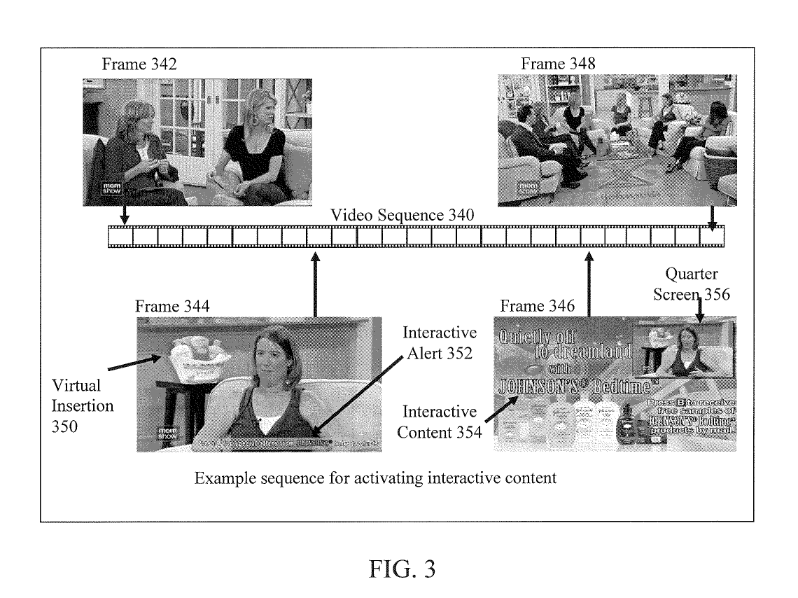

FIG. 3 outlines an example of using virtual insertion integrated into the video in combination with interactive content, according to an embodiment. FIG. 3 displays multiple frames of a video sequence 340. The start frame of the sequence is 342, and does not contain special video content. Frame 344 contains a virtual insertion 350 of a sponsor's product realistically integrated into the scene. An interactive alert message is provided 352 signaling that a special offer is available from the sponsor, related to the product placement. Frame 346 illustrates the user view when the interactive button is pressed. It contains detailed content about the product 354 with further interactive option to get the free coupon. Meanwhile, the main view shrunk to one-quarter view 356. The final frame 348 returns the video to the main program containing advertisement that is not interactive (Johnson & Johnson on the rug, and virtual place product in the back table). In some cases, rather than the main view being shrunk, a graphic or advertisement may be overlaid onto or integrated into the program display. This may include integration in the foreground of physical objects in a scene.

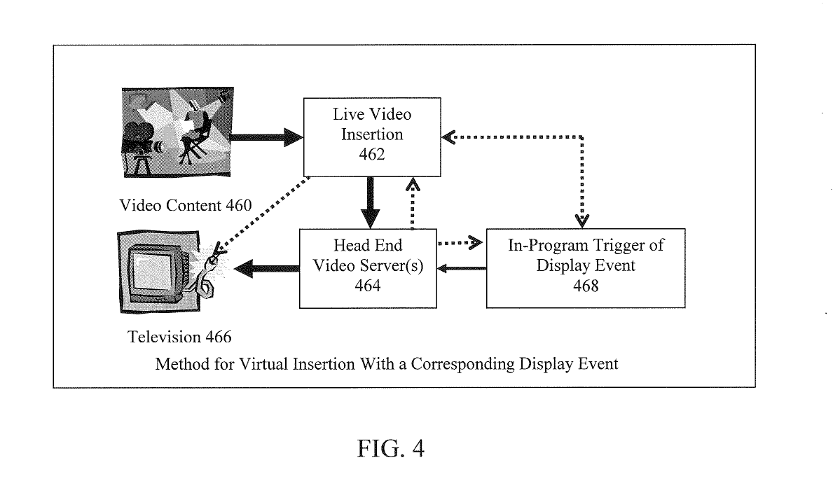

FIG. 4 displays an exemplary embodiment of this invention incorporating the use of virtual insertions for the cable television viewer, according to an embodiment. Video content 460 is streamed live from a production facility or playback device. A video insertion module 462 may render into the video stream using pre-determined metadata or metadata derived through video analysis in real-time or near real-time. The insertion module 462 may be configured to deteiinine a display event in real time based on the video content analysis upon recognition of a display event trigger. Insertion module 462 may also be configured to display, or prepare for display, the display event in the program display. The head-end video server 464 streams the live content through the cable distribution channel to the end-user television 466. Interactive content is enabled by a trigger mechanism 468 that is determined during the video program being observed by the end-user. Trigger mechanism 468 may be configured to perform a video content analysis of a program display and recognize a display event trigger based on the video content analysis. For the example in FIG. 3, according to some embodiments, the same mechanism to trigger the virtual insert may be used to trigger the interactive session. The mechanism to trigger interactivity may be downstream of the virtual insertion, and may be set based on whether the virtual insertion is present in the video sequence. In some cases, trigger mechanism 468 may be a part of video insertion module 462.

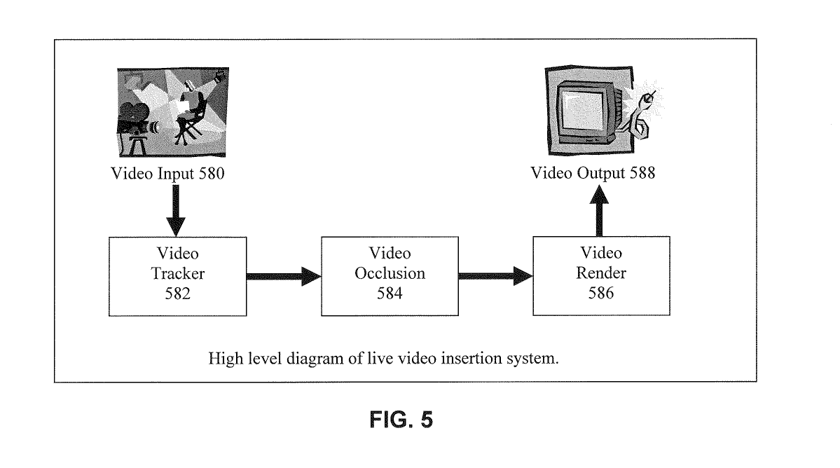

One embodiment of the live video insertion system module 462 in FIG. 4 is shown in greater detail in FIG. 5. Program video may be system input 580. Video tracker 582 may analyze incoming video for landmarks in the scene to produce a representation of the camera orientation by analyzing the scene shown in the video and the subsequent motion. Video tracker 582 may update the position over time through frame to frame analysis of features in the video, such as texture analysis. These object tracking techniques are well known in the field and may be implemented using techniques discussed in U.S. Pat. Nos. 5,808,695 and 6,529,613; the content of both are hereby incorporated by reference. Video occlusion 584 may apply color analysis to distinguish foreground objects from background on a pixel by pixel basis. Chromakeying techniques to handle object occlusion are well known by those familiar with the art. The video render 586 may receive the camera orientation information from video tracker 582 and uses this to render artwork realistically into the video scene. It uses the occlusion mask to appropriately key out foreground objects so they appear to be positioned in front of the rendered artwork.

Video tracker 582 and video occlusion 584 in FIG. 5 may employ computationally intensive operations that are tied to the specific video content, according to an embodiment. In some cases, it may be convenient if these operations are computed off-line, and only video render 586 is computed in real-time. This may be achieved by storing the metadata off-line, and retrieving it during a live render. Advertisements or interactive session data may be received at video render 586 in some cases. The data may be synchronized to the video frame using the time code or a cycle redundancy check (CRC) calculation. It may be useful, according to some embodiments, to keep the render as a live operation, since this allows changing the graphics between broadcast of programs, as well as targeting inserts for particular market support by a given head-end. Note, an embodiment may also include a situation where video occlusion 584 is live, and video tracker 582 is pre-produced. In some cases, video occlusion 584 may be omitted.

The live video insertion system module 462 in FIG. 4 may be positioned at multiple locations, according to an embodiment. For a live television broadcast over cable, these may include:
The production facility where program video is created. This has the natural advantage that the show can be modified to provide the best opportunities creating a realistic insert.
The studio where commercials are added. This has the advantage of being a central location that interactivity for multiple programs can be coordinated from a single location.
The head-end where the video is streamed and interactivity is enabled. This makes the sense from the perspective that it controls the flow of video to a regional area.
The end-user location where number of viewers of the program is counted. This would be ideal for targeting an ad to an individual end user.

The use of virtual insertions (FIG. 3) opens up new opportunities for advertisers. The inserted graphic can be changed with each broadcast or viewing of the program content. Also, in some cases, inserted graphics can be targeted to particularly geographic areas by inserting them at the head-end. The virtual insertions discussed here can be either pre-produced or inserted live during the viewing of the content. Embodiments may also include inserting graphics live at the end-user level, as considered in U.S. patent application Ser. No. 12/424,056, the contents of which are hereby incorporated by reference.

For viewers using digital video recorders, the system may enable interactive content or virtual advertisement whenever the viewer skips over 30 second spots, according to an embodiment. Alternately, in some embodiments, interactive content or virtual advertisement may be enabled periodically for sporting event playback since game-time may be determined from the broadcast graphic 228 (FIG. 2). Furthermore, other embodiments may trigger insertion of interstitial ads during playback based on measuring time elapse on the game clock or user interaction (such as 30 second jumps). The use of other trigger mechanisms associated with FIG. 2 may be used for this purpose as well. In some cases, these interstitial ads could be reduced in length compared to 30 second spots, making them more palatable to the end user.

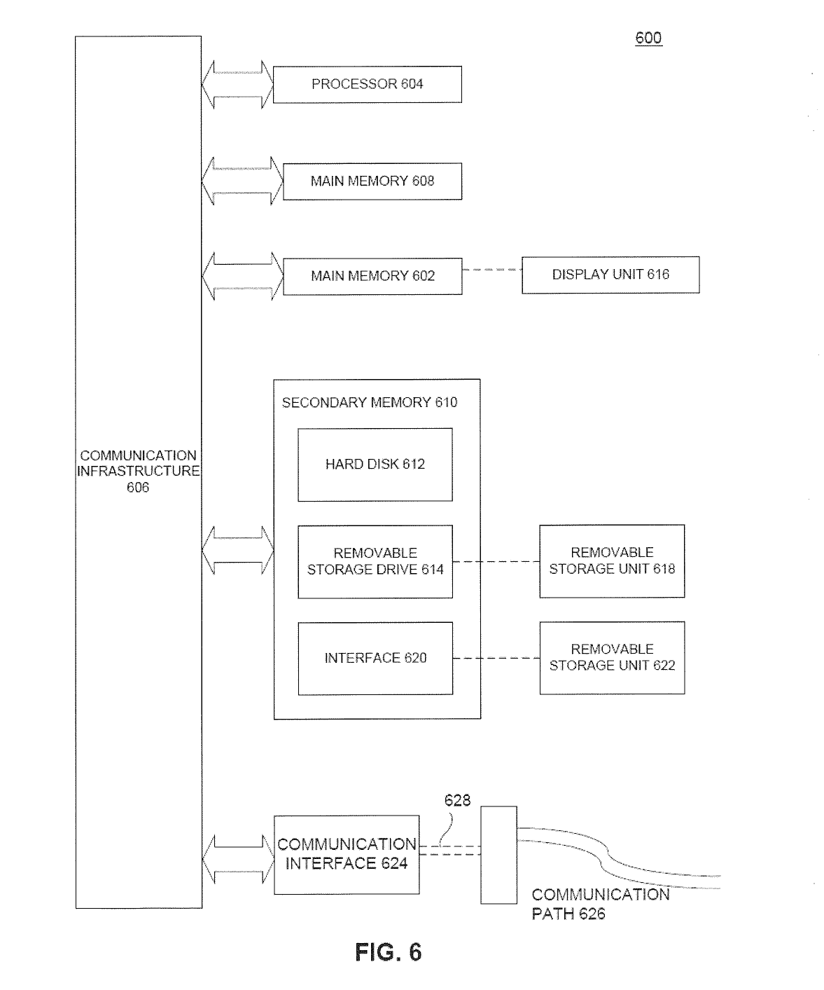

Aspects of the present invention, for the exemplary systems shown in FIGS. 1-5 or any part(s) or function(s) thereof may be implemented using hardware, software modules, firmware, tangible computer readable or computer usable storage media having instructions stored thereon, or a combination thereof and may be implemented in one or more computer systems or other processing systems. FIG. 6 illustrates an example computer system 600 in which the present invention, or portions thereof, can be implemented as computer-readable code. For example, video server 102, trigger mechanism 106, insertion module 462, trigger mechanism 468, video server 464, video tracker 582, video occlusion 584, video render 586 and/or any other components of the exemplary systems shown in FIGS. 1-5 can be implemented in hardware, firmware, or as computer-readable code on a computer system such as computer system 600. After reading this description, it will become apparent to a person skilled in the relevant art how to implement the invention using other computer systems and/or computer architectures.

Computer system 600 includes one or more processors, such as processor 604. Processor 604 can be a special purpose or a general purpose processor. Processor 604 is connected to a communication infrastructure 606 (for example, a bus or network).

Computer system 600 also includes a main memory 608, preferably random access memory (RAM), and may also include a secondary memory 610. Secondary memory 610 may include, for example, a hard disk drive 612 and/or a removable storage drive 614. Removable storage drive 614 may comprise a floppy disk drive, a magnetic tape drive, an optical disk drive, a flash memory, or the like. The removable storage drive 614 reads from and/or writes to a removable storage unit 618 in a well known manner. Removable storage unit 618 may comprise a floppy disk, magnetic tape, optical disk, etc. which is read by and written to by removable storage drive 614. As will be appreciated by persons skilled in the relevant art(s), removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, a wireless card, or the like. Software and data transferred via communications interface 624 are in the form of signals which may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, a hard disk installed in hard disk drive 612, and signals carried over communications path 626. Computer program medium and computer usable medium can also refer to memories, such as main memory 608 and secondary memory 610, which can be memory semiconductors (e.g. DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor 604 to implement the processes of the present invention, such as the steps in the methods described above. Accordingly, such computer programs represent controllers of the computer system 600. Where the invention is implemented using software, the software may be stored in a computer program product and loaded into computer system 600 using removable storage drive 614, interface 620, hard drive 612 or communications interface 624.

Embodiments of the invention also may be directed to computer products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for triggering an in-program display event comprising:
performing a video content analysis of a program display;
determining a display event trigger in real time based on the video content analysis; and
displaying a display event in the program display based on the display event trigger.

2. The method of claim 1, wherein the displaying the display event includes displaying a video graphic.

3. The method of claim 1, wherein the displaying the display event includes displaying an interactive session.

4. The method of claim 3, wherein the displaying includes displaying the display event based on user input requested and received from a user.

5. The method of claim 3, wherein the displaying an interactive session includes displaying the interactive session based on an interactive session history.

6. The method of claim 1, further comprising determining in real time the display event based on the video content analysis.

7. The method of claim 1, further comprising determining in real time when to display the display event based on the video content analysis.

8. The method of claim 1, wherein the performing a video content analysis includes analyzing one or more portions of a scene of the program display.

9. The method of claim 1, wherein the performing a video content analysis includes analyzing an inserted graphic of the program display.

10. The method of claim 1, wherein the performing a video content analysis includes analyzing audio of the program display.

11. The method of claim 1, further comprising analyzing data from other data sources corresponding to the program display.

12. The method of claim 1, wherein the performing a video content analysis includes analyzing one or more events in a scene of the program display.

13. The method of claim 1, wherein the performing a video content analysis includes performing a video content analysis at a location remote from the venue of the event.

14. The method of claim 1, wherein the performing a video content analysis includes determining a sporting event game time.

15. A method for triggering an in-program display event comprising:
receiving camera information corresponding to a program display;
determining a display event trigger in real time based on the camera information; and
displaying a display event in the program display based on the display event trigger.

16. A method for providing an in-program interactive session comprising:
receiving trigger information in real time for triggering an in-program display event;
displaying the display event in the program display based on the display event trigger,
providing the in-program interactive session, wherein the in-program interactive session includes enabling a user to provide input to alter the in-program display event.

17. The method of claim 16, further comprising synchronizing the in-program interactive session with video content.

18. A system for triggering an in-program display event comprising:
a trigger mechanism configured to
perform a video content analysis of a program display; and
determine a display event trigger in real time based on the video content analysis; and
an insertion module configured to display a display event in the program display based on the display event trigger.

19. The system of claim 18, wherein the insertion module is further configured to determine in real time the display event based on the video content analysis.

20. The system of claim 18, further wherein the insertion module is further configured to determine in real time when to display the display event based on the video content analysis.

21. The system of claim 18, wherein the insertion module is further configured to display a video graphic.

22. The system of claim 18, wherein the insertion module is further configured to display an interactive session.

23. The system of claim 22, wherein the insertion module is further configured to display the display event based on user input requested and received from a user.

24. The system of claim 22, wherein the insertion module is further configured to display the interactive session based on an interactive session history.

25. The system of claim 18, wherein the trigger mechanism is further configured to analyze one or more portions of a scene of the program display.

26. The system of claim 18, wherein the trigger mechanism is further configured to analyze an inserted graphic of the program display.

27. The system of claim 18, wherein the trigger mechanism is further configured to analyze audio of the program display.

28. The system of claim 18, wherein the trigger mechanism is further configured to analyze data from other data sources corresponding to the program display.

29. The system of claim 18, wherein the trigger mechanism is further configured to analyze one or more events in a scene of the program display.

30. The system of claim 18, wherein the trigger mechanism is further configured to detennine a sporting event game time.

31. A system for triggering an in-program interactive session comprising:
a trigger mechanism configured to:
receive camera information corresponding to a program display; and
determine a display event trigger in real time based on the camera information; and
an insertion module configured to display a display event in the program display based on the display event trigger.

32. A system for triggering an in-program interactive session comprising:
a trigger mechanism configured to receive trigger information for triggering an in-program display event; and
an insertion module configured to
display the display event in the program display based on the display event trigger; and
provide the in-program interactive session, wherein the in-program interactive session enables a user to provide input to alter the in-program display event.
